(19) United States
(12) Patent Application Publication
(10) Pub. No.: US 2015/0335049 A1
(43) Pub. Date: Nov. 26, 2015

(54) LIQUID STEVIA COMPOSITIONS

(71) Applicant: CARGILL, INCORPORATED, Wayzata, MN (US)

(72) Inventors: Robert Joshua Brower, III, Clayton, OH (US); Ting Liu Carlson, Marietta, SC (US); Christopher Edward Delfosse, Minneapolis, MN (US); Nathan Edward Knutson, Maple Grove, MN (US)

(73) Assignee: Cargill, Incorporated, Wayzata, MN (US)

(21) Appl. No.: 14/758,933

(22) PCT Filed: Jan. 6, 2014
(86) PCT No.: PCT/US14/10294

§ 371 Date: Jul. 1, 2015

Related U.S. Application Data
(60) Provisional application No. 61/749,037, filed on Jan. 4, 2013.
(60) Provisional application No. 61/764,727, filed on Feb. 14, 2013.

(51) Int. Cl. A23L 1/236; A23L 2/60

(52) U.S. Cl. CPC A23L 1/2366; A23L 2/60; A23V 2002/00

(57) ABSTRACT

A liquid stevia composition is described. The liquid stevia composition includes a stevia component, a syrup component, ethanol, water, and glycerol.

### FIELD OF THE INVENTION

This document relates to liquid stevia compositions and methods of producing liquid stevia compositions.

### BACKGROUND OF THE INVENTION

Obesity is becoming a concern in the United States and many other societies throughout the world. One common method of controlling obesity is through the use of non-caloric or low caloric sweeteners rather than sugars because sugars are a major source of calories. One particular group of natural non-caloric high intensity sweeteners which are gaining popularity are those derived from Stevia.

The species Stevia rebauchana (“Stevia”) has been the subject of considerable research and development efforts directed at the purification of certain naturally occurring sweet glycosides of Stevia that have potential as non-caloric sweeteners. Sweet glycosides that may be extracted from Stevia include the six rebaudiosides (i.e., rebaudioside A to F), stevioside, and dulcoside A. In particular, significant commercial interest has been focused on obtaining and purifying rebaudioside A from Stevia.

Non caloric or low caloric sweeteners can be delivered to consumers through solid or liquid applications. For example, packets of dry sweeteners are commonly used for sweetening coffee or other consumable products by sprinkling the contents of the packages over such products.

Non caloric or low caloric sweeteners can also be delivered in liquid form. Some liquid sweeteners are stored in containers having an eyedropper type lid. Consumers hold the container with one hand, remove the lid and squeeze the eyedropper to apply drops of the sweetener to the consumable products. Alternately liquid sweeteners can be stored in squeezable containers. After removing the lid, these containers can be flipped and squeezed to apply the liquid sweetener to consumable products. Other means for delivering or dispensing liquid sweeteners are also possible.

### SUMMARY OF THE INVENTION

The present invention relates to liquid stevia compositions. Applicants have surprisingly discovered a particular combination of ingredients which allows a high concentration of a stevia component to remain in solution for a long period of time. In some embodiments, the present invention also includes a very low level of ethanol.

Some liquid stevia compositions include ingredients which may not be desired in certain applications, such as preservatives. Some non-desirable ingredients, such as propylene glycol, may be added to maintain the stevia in solution for a long period of time. Preservatives may be used to maintain freshness or control microbiological activity. The present invention surprisingly provides a liquid stevia composition which can maintain a large concentration of the stevia component in solution for a long period of time without some of these undesirable ingredients.

One aspect of the invention features a liquid stevia composition including a stevia component, a syrup component, ethanol, water, and glycerol. In some examples, this aspect further includes erythritol.

Another aspect of the invention features a liquid stevia composition including a stevia component, a syrup component, ethanol, water, and erythritol. In some examples, this aspect further includes glycerol.

In certain embodiments of the above aspects, the stevia component makes up at least 2% of the composition. In other embodiments, the stevia component makes up at least 4% of the composition.

In other embodiments, the syrup component is an invert sugar syrup. The invert sugar syrup can be a high invert sugar syrup or a full invert sugar syrup.

In yet other embodiments, ethanol can make up less than 20%, or even less than 10% of the composition.

Other objects, features, and advantages of the invention will be apparent from the following detailed description and claims.

### DETAILED DESCRIPTION OF THE INVENTION

One aspect of the invention features a liquid stevia composition including a stevia component, a syrup component, ethanol, water, and glycerol.

The term “stevia component”, as used herein, means a relatively pure glycoside or blend of glycosides isolated from stevia plants. Purity, as used here, represents the weight percentage of a particular glycoside of the stevia component. The stevia component comprises a particular glycoside or glycosides at a particular purity with the remainder of the stevia component made up of a mixture of the other glycosides.

Glycosides of particular interest for their high level of sweetness and/or low level of bitterness include rebaudioside A, rebaudioside B, and rebaudioside D. It can be a challenge, however, to maintain one of these (or a blend of these) glycosides at a high level of purity in solution for a long period of time. Rebaudioside A, at approximately 95% purity, has an equilibrium solubility in water of about 0.8% at ambient temperature. Highly pure rebaudioside B and rebaudioside D have an even lower equilibrium solubility in water. The present invention provides a mixture of ingredients that allows a large percentage of these highly pure glycosides to remain in solution for long periods of time.

In one embodiment, the stevia component has a rebaudioside A purity greater than 70% by weight. In another embodiment, the stevia component has a rebaudioside A purity greater than 75% by weight. In yet another embodiment, the stevia component has a rebaudioside A purity greater than 80% by weight. In yet another embodiment, the stevia component has a rebaudioside A purity greater than 85% by weight. In yet another embodiment, the stevia component has a rebaudioside A purity greater than 90% by weight. In yet another embodiment, the stevia component has a rebaudioside A purity greater than 95% by weight. In yet another embodiment, the stevia component has a rebaudioside A purity greater than 97% by weight. Stevia components with high percentage of rebaudioside A can be referred to herein as Reb A stevia components.

As described above, the equilibrium solubility of highly pure rebaudioside B and rebaudioside D are even lower than that of highly pure rebaudioside A. For example, rebaudioside B at approximately 95% purity has an equilibrium solubility in water of about 200 ppm (0.02%) at ambient temperature, and rebaudioside D at approximately 95% purity has an equilibrium solubility of about 800 ppm (0.08%) at ambient temperature. Thus, it is even more difficult to maintain rebaudioside B and rebaudioside D in solution than rebaudioside A.

Some embodiments of the present invention comprise a stevia component which includes a large percentage of rebaudioside B. Other embodiments comprise a stevia component which includes a large percentage of rebaudioside D. Yet other embodiments comprise a stevia component which includes a large percentage of a blend of rebaudioside B and rebaudioside D. Yet other embodiments comprise a stevia component which includes a large percentage of a blend of rebaudioside A and rebaudioside B. Yet other embodiments comprise a stevia component which includes a large percentage of a blend of rebaudioside A and rebaudioside D. Yet other embodiments comprise a stevia component which includes a large percentage of a blend of rebaudioside A, rebaudioside B, and rebaudioside D.

In some embodiments, the stevia component has a rebaudioside B purity greater than 40% by weight. In yet another embodiment, the stevia component has a rebaudioside B purity greater than 50% by weight. In yet another embodiment, the stevia component has a rebaudioside B purity greater than 60% by weight. In yet another embodiment, the stevia component has a rebaudioside B purity greater than 70% by weight. In yet another embodiment, the stevia component has a rebaudioside B purity greater than 80% by weight. In yet another embodiment, the stevia component has a rebaudioside B purity greater than 90% by weight. In yet another embodiment, the stevia component has a rebaudioside B purity greater than 95% by weight. In yet another embodiment, the stevia component has a rebaudioside B purity greater than 97% by weight. Stevia components with high percentage of rebaudioside B can be referred to herein as Reb B stevia components.

In other embodiments, the stevia component has a rebaudioside D purity greater than 40% by weight. In yet another embodiment, the stevia component has a rebaudioside D purity greater than 50% by weight. In yet another embodiment, the stevia component has a rebaudioside D purity greater than 60% by weight. In yet another embodiment, the stevia component has a rebaudioside D purity greater than 0.70% by weight. In yet another embodiment, the stevia component has a rebaudioside D purity greater than 80% by weight. In yet another embodiment, the stevia component has a rebaudioside D purity greater than 90% by weight. In yet another embodiment, the stevia component has a rebaudioside D purity greater than 95% by weight. In yet another embodiment, the stevia component has a rebaudioside D purity greater than 97% by weight. Stevia components with high percentage of rebaudioside D can be referred to herein as Reb D stevia components.

In yet other embodiments, the stevia component comprises a blend of rebaudioside B and rebaudioside D. In some of these embodiments, the combination of rebaudioside B and rebaudioside D makes up at least 40% of the stevia component by weight. In other embodiments, the combination of rebaudioside B and rebaudioside D makes up at least 50% of the stevia component by weight. In yet other embodiments, the combination of rebaudioside B and rebaudioside D makes up at least 60% of the stevia component by weight. In yet other embodiments, the combination of rebaudioside B and rebaudioside D makes up at least 70% of the stevia component by weight. In yet other embodiments, the combination of rebaudioside B and rebaudioside D makes up at least 80% of the stevia component by weight. In yet other embodiments, the combination of rebaudioside B and rebaudioside D makes up at least 90% of the stevia component by weight. In yet other embodiments, the combination of rebaudioside B and rebaudioside D makes up at least 95% of the stevia component by weight. In yet other embodiments, the combination of rebaudioside B and rebaudioside D makes up at least 97% of the stevia component by weight. Stevia components with which are made up of high percentage of a blend of rebaudioside B and rebaudioside D can be referred to herein as Reb BD stevia components.

In some embodiments, the Reb BD stevia component comprises from 15% to 85% rebaudioside B and from 15% to 85% rebaudioside D (of the total rebaudioside B and rebaudioside D in the Reb BD stevia component). In other embodiments, the Reb BD stevia component comprises from 20% to 50% rebaudioside B and from 50% to 80% rebaudioside D (of the total rebaudioside B and rebaudioside D in the Reb BD stevia component). In yet other embodiments, the Reb BD stevia component comprises from 30% to 40% rebaudioside B and from 60% to 70% rebaudioside D (of the total rebaudioside B and rebaudioside D in the Reb BD stevia component).

In yet other embodiments, the stevia component comprises a blend of rebaudioside A and rebaudioside B. In some of these embodiments, the combination of rebaudioside A and rebaudioside B makes up at least 40% of the stevia component by weight. In other embodiments, the combination of rebaudioside A and rebaudioside B makes up at least 50% of the stevia component by weight. In yet other embodiments, the combination of rebaudioside A and rebaudioside B makes up at least 60% of the stevia component by weight. In yet other embodiments, the combination of rebaudioside A and rebaudioside B makes up at least 70% of the stevia component by weight. In yet other embodiments, the combination of rebaudioside A and rebaudioside B makes up at least 80% of the stevia component by weight. In yet other embodiments, the combination of rebaudioside A and rebaudioside B makes up at least 90% of the stevia component by weight. In yet other embodiments, the combination of rebaudioside A and rebaudioside B makes up at least 95% of the stevia component by weight. In yet other embodiments, the combination of rebaudioside A and rebaudioside B makes up at least 97% of the stevia component by weight. Stevia components with which are made up of high percentage of a blend of rebaudioside A and rebaudioside B can be referred to herein as Reb AB stevia components.

In some embodiments, the Reb AB stevia component comprises from 15% to 85% rebaudioside A and from 15% to 85% rebaudioside 13 (of the total rebaudioside A and rebaudioside 13 in the Reb AB stevia component). In other embodiments, the Reb AB stevia component comprises from 20% to 50% rebaudioside A and from 50% to 80% rebaudioside B (of the total rebaudioside A and rebaudioside B in the Reb AB stevia component). In yet other embodiments, the Reb AB stevia component comprises from 30% to 40% rebaudioside A and from 60% to 70% rebaudioside B (of the total rebaudioside A and rebaudioside B in the Reb AB stevia component).

In yet other embodiments, the stevia component comprises a blend of rebaudioside A and rebaudioside D. In some of these embodiments, the combination of rebaudioside A and rebaudioside D makes up at least 40% of the stevia component by weight. In other embodiments, the combination of rebaudioside A and rebaudioside D makes up at least 50% of the stevia component by weight. In yet other embodiments, the combination of rebaudioside A and rebaudioside D makes up at least 60% of the stevia component by weight. In yet other embodiments, the combination of rebaudioside A and rebaudioside D makes up at least 70% of the stevia component by weight. In yet other embodiments, the combination of rebaudioside A and rebaudioside D makes up at least 80% of the stevia component by weight. In yet other embodiments, the combination of rebaudioside A and rebaudioside D makes up at least 90% of the stevia component by weight. In yet other embodiments, the combination of rebaudioside A and rebaudioside D makes up at least 95% of the stevia component by weight. In yet other embodiments, the combination of rebaudioside A and rebaudioside D makes up at least 97% of the stevia component by weight. Stevia components with which are made up of high percentage of a blend of rebaudioside A and rebaudioside D can be referred to herein as Reb AD stevia components.

In some embodiments, the Reb AD stevia component comprises from 15% to 85% rebaudioside A and from 15% to 85% rebaudioside D (of the total rebaudioside A and rebaudioside D in the Reb AD stevia component). In other embodiments, the Reb AD stevia component comprises from 30% to 70% rebaudioside A and from 30% to 70% rebaudioside D (of the total rebaudioside A and rebaudioside D in the Reb AD stevia component). In yet other embodiments, the Reb AD stevia component comprises from 40% to 60% rebaudioside A and from 40% to 60% rebaudioside D (of the total rebaudioside A and rebaudioside D in the Reb AD stevia component).

In yet other embodiments, the stevia component comprises a blend of rebaudioside A, rebaudioside B, and rebaudioside D. In some of these embodiments, the combination of rebaudioside A, rebaudioside B, and rebaudioside D makes up at least 80% of the stevia component by weight. In other embodiments, the combination of rebaudioside A, rebaudioside B, and rebaudioside D makes up at least 90% of the stevia component by weight. In yet other embodiments, the combination of rebaudioside A, rebaudioside B, and rebaudioside D makes up at least 95% of the stevia component by weight. In yet other embodiments, the combination of rebaudioside A, rebaudioside B, and rebaudioside D makes up at least 97% of the stevia component by weight. Stevia components with which are made up of high percentage of a blend of rebaudioside A, rebaudioside B, and rebaudioside D can be referred to herein as Reb ABD stevia components.

In some embodiments, the Reb ABD stevia component comprises from 30% to 50% rebaudioside A, from 10% to 30% rebaudioside B, and 30% to 50% rebaudioside D (of the total rebaudioside A, rebaudioside B, and rebaudioside D in the Reb ABD stevia component). In other embodiments, the Reb ABD stevia component comprises from 35% to 45% rebaudioside A, from 15% to 25% rebaudioside B, and 35% to 45% rebaudioside D (of the total rebaudioside A, rebaudioside B, and rebaudioside D in the Reb ABD stevia component).

The stevia component can make up a significant percentage of the liquid stevia composition. In some embodiments, a Reb A stevia component comprises at least 2% of the liquid stevia composition. In other embodiments, the Reb A stevia component comprises at least 3% of the liquid stevia composition. In yet other embodiments, the Reb A stevia component comprises at least 4% of the liquid stevia composition. In yet other embodiments, the Reb A stevia component comprises at least 4.5% of the liquid stevia composition. In yet other embodiments, the Reb A stevia component comprises at least 5% of the liquid stevia composition. In yet other embodiments, the Reb A stevia component comprises between 2% and 15% of the liquid stevia composition. In yet other embodiments, the Reb A stevia component comprises between 3% and 10% of the liquid stevia composition. In yet other embodiments, the Reb A stevia component comprises between 4% and 8% of the liquid stevia composition.

In other embodiments, a Reb D stevia component comprises at least 0.2% of the liquid stevia composition. In yet other embodiments, the Reb D stevia component comprises at least 0.4% of the liquid stevia composition. In yet other embodiments, the Reb D stevia component comprises from 0.4% to 0.7% of the liquid stevia composition. In yet other embodiments, the Reb D stevia component comprises at least 0.7% of the liquid stevia composition. In yet other embodiments, the Reb D stevia component comprises at least 1% of the liquid stevia composition. In yet other embodiments, the Reb D stevia component comprises at least 1.5% of the liquid stevia composition. In yet other embodiments, the Reb D stevia component comprises at least 2% of the liquid stevia composition. In yet other embodiments, the Reb D stevia component comprises at least 3% of the liquid stevia composition. In yet other embodiments, the Reb D stevia component comprises at least 4% of the liquid stevia composition.

In other embodiments, a Reb B stevia component comprises at least 0.1% of the liquid stevia composition. In yet other embodiments, the Reb B stevia component comprises at least 0.2% of the liquid stevia composition. In yet other embodiments, the Reb B stevia component comprises at least 0.4% of the liquid stevia composition. In yet other embodiments, the Reb B stevia component comprises at least 0.7% of the liquid stevia composition. In yet other embodiments, the Reb B stevia component comprises at least 1% of the liquid stevia composition. In yet other embodiments, the Reb B stevia component comprises at least 1.5% of the liquid stevia composition. In yet other embodiments, the Reb B stevia component comprises at least 2% of the liquid stevia composition. In yet other embodiments, the Reb B stevia component comprises at least 3% of the liquid stevia composition. In yet other embodiments, the Reb B stevia component comprises at least 4% of the liquid stevia composition.

In other embodiments, a Reb BD stevia component comprises at least 0.1% of the liquid stevia composition. In yet other embodiments, the Reb BD stevia component comprises at least 0.2% of the liquid stevia composition. In yet other embodiments, the Reb BD stevia component comprises at least 0.4% of the liquid stevia composition. In yet other embodiments, the Reb BD stevia component comprises at least 0.7% of the liquid stevia composition. In yet other embodiments, the Reb BD stevia component comprises at least 1% of the liquid stevia composition. In yet other embodiments, the Reb BD stevia component comprises at least 1.5% of the liquid stevia composition. In yet other embodiments, the Reb BD stevia component comprises at least 2% of the liquid stevia composition. In yet other embodiments, the Reb BD stevia component comprises at least 3% of the liquid stevia composition. In yet other embodiments, the Reb BD stevia component comprises at least 4% of the liquid stevia composition.

In other embodiments, a Reb AB stevia component comprises at least 0.3% of the liquid stevia composition. In yet other embodiments, the Reb AB stevia component comprises at least 0.4% of the liquid stevia composition. In yet other embodiments, the Reb AB stevia component comprises at least 0.6% of the liquid stevia composition. In yet other embodiments, the Reb AB stevia component comprises at least 0.7% of the liquid stevia composition. In yet other embodiments, the Reb AB stevia component comprises at least 0.8% of the liquid stevia composition.

In other embodiments, a Reb AD stevia component comprises at least 0.3% of the liquid stevia composition. In yet other embodiments, the Reb ABD stevia component comprises at least 0.5% of the liquid stevia composition. In yet other embodiments, the Reb AD stevia component comprises at least 0.6% of the liquid stevia composition. In yet other embodiments, the Reb AD stevia component comprises at least 0.8% of the liquid stevia composition. In yet other embodiments, the Reb AD stevia component comprises at least 1% of the liquid stevia composition.

In other embodiments, a Reb ABD stevia component comprises at least 0.4% of the liquid stevia composition. In yet other embodiments, the Reb ABD stevia component comprises at least 0.6% of the liquid stevia composition. In yet other embodiments, the Reb ABD stevia component comprises at least 0.8% of the liquid stevia composition. In yet other embodiments, the Reb ABD stevia component comprises at least 1% of the liquid stevia composition. In yet other embodiments, the Reb ABD stevia component comprises at least 1.3% of the liquid stevia composition.

The stevia component can be maintained in solution for long periods of time in the present invention. To be maintained in solution means that the stevia component does not crystallize or precipitate out of solution. The stevia component is no longer maintained in solution if the solution becomes cloudy or crystals become visible in the solution. In some embodiments, the stevia component is maintained in solution for at least 13 days. In other embodiments, the stevia component is maintained in solution for at least 30 days. In yet other embodiments, the stevia component is maintained in solution for at least 35 days. In yet other embodiments, the stevia component is maintained in solution for at least 98 days. In yet other embodiments, the stevia component is maintained in solution for at least 182 days.

The term “syrup component”, as used herein, means a syrup made up primarily of a mixture of glucose, fructose, or various oligoglucoses. Common examples of compositions which could function as the syrup component include invert sugar syrup, high fructose corn syrup (with varying ratios of glucose to fructose), honey, agave nectar, molasses, and corn syrup. Preferably, the syrup component is an invert sugar syrup.

An invert sugar syrup refers to glucose-fructose based syrup that results from the hydrolysis of sucrose into glucose and fructose. A high invert sugar syrup refers to an invert sugar syrup in which at least 90% of the mixture is made up of glucose and fructose (the remaining portion is residual sucrose). A full invert sugar syrup refers to an invert sugar syrup in which sucrose has been fully inverted to glucose and fructose. In some preferred embodiments, the syrup component is a high invert sugar syrup. In other preferred embodiments, the syrup component is a full invert sugar syrup.

In some embodiments, the syrup component comprises from 5% to 50% of the liquid stevia composition. In other embodiments, the syrup component comprises from 10% to 40% of the liquid stevia composition. In yet other embodiments, the syrup component comprises from 15% to 35% of the liquid stevia composition.

A small amount of ethanol is utilized in the present invention. In some embodiments, the ethanol comprises less than 50% of the liquid stevia composition. In other embodiments, the ethanol comprises less than 40% of the liquid stevia composition. In yet other embodiments, the ethanol comprises less than 30% of the liquid stevia composition. In yet other embodiments, the ethanol comprises less than 20% of the liquid stevia composition. In yet other embodiments, the ethanol comprises less than 15% of the liquid stevia composition. In yet other embodiments, the ethanol comprises less than 12% of the liquid stevia composition.

Glycerol is also included in the present invention. In some embodiments, glycerol comprises from 10% to 60% of the liquid stevia composition. In other embodiments, glycerol comprises from 20% to 50% of the liquid stevia composition.

Another aspect of the invention features a liquid stevia composition including a stevia component, a syrup component, ethanol, water, and erythritol. In this aspect, erythritol replaces the glycerol in the aspect of the invention described above.

In these embodiments, erythritol comprises from 10% to 60% of the liquid stevia composition. In other embodiments, erythritol comprises from 20% to 50% of the liquid stevia composition.

Certain other aspects of the invention include both glycerol and erythritol along with the other ingredients mentioned in the liquid stevia composition.

In these embodiments, the combination of erythritol and glycerol comprises from 20% to 60% of the liquid stevia composition. In another embodiment, the combination of erythritol and glycerol comprises from 30% to 60% of the liquid stevia composition.

The present invention also pertains to methods for producing a liquid stevia composition. The method includes (a) heating a stevia component in water at a sufficiently high temperature and for a sufficient period of time to dissolve the stevia component in water to yield a heated stevia water solution, and (b) blending the heated stevia water solution with a syrup component, ethanol, and glycerol.

In step (a), the amount of stevia component dissolved in water can vary. In some embodiments, the stevia component makes up from 10% to 60% of the heated stevia water solution. In other embodiments, the stevia component makes up from 10% to 50% of the heated stevia water solution. In yet other embodiments, the stevia component makes up from 20% to 40% of the heated stevia water solution.

In step (a) the temperature should be raised such that the stevia component dissolves in water. In some embodiments, the temperature can be raised to between 50° C. and 99° C. In other embodiments, the temperature can be raised to between 70° C. and 98° C. In yet other embodiments, the temperature can be raised to between 85° C. and 97° C. In yet other embodiments, the temperature can be raised to about 95° C.

In step (a), the stevia component in water should be heated for a time sufficient to sufficient to dissolve the stevia component in water, for example for at least 15 minutes, 30 minutes, 45 minutes, or 1 hour.

In step (b), the heated stevia water solution can be blended with the syrup component, ethanol, and glycerol using blending techniques known in the art. The heated stevia water solution should be blended with the other ingredients while the stevia component is still dissolved in water.

In some embodiments, erythritol can be utilized instead of glycerol. In other embodiments, both erythritol and glycerol can be utilized.

The liquid stevia compositions can be added to beverages to provide added sweetness to such beverages without added caloric content.

Because the liquid stevia compositions remain in solution for long periods of time, the composition can have a long shelf life. Additionally, certain consumers may find the inclusion of natural ingredients in the liquid stevia compositions (without preservatives) to be beneficial.

The liquid stevia compositions of the present invention can also include other ingredients. In some embodiments, the liquid stevia compositions can further include another high intensity sweetener, a flavoring, an antioxidant, caffeine, a nutritive sweetener, salts, protein, or a sweetness enhancer.

### EXAMPLES

### Example 1

A 30% solution of high purity rebaudioside A (30% RA95) in water was made in the following manner: High purity rebaudioside A (approximately 95% pure) was obtained from Cargill, Incorporated (lot CV0706604). This rebaudioside A was added to water to produce a 30% solution and was heated in a 95° C. water bath for 1 hour to dissolve.

Invert sugar syrup was produced in the following manner: A 70% sucrose solution in water was adjusted to pH 2.44 with citric acid. Hydrolysis of sucrose was allowed to proceed for 2 hours at 95° C. to produce a mixture of glucose and fructose (invert sugar syrup).

The 30% RA95 and invert sugar syrup were mixed with the other ingredients (glycerol, ethanol, water) in a weight basis to produce the 9 samples seen in Table 1 below.

TABLE 1

| | | 70% Invert | | | |
|---|---|---|---|---|---|
| | 30% RA95 | sugar syrup | Glycerol | Ethanol | Water |
| Sample | (g) | (g) | (g) | (g) | (g) |
| 1 | 1.6 | 8.4 | — | — | — |
| 2 | 1.6 | 2.4 | 5 | 1 | — |
| 3 | 1.6 | 3.4 | — | 5 | — |
| 4 | 1.6 | — | 5 | 3.4 | — |
| 5 | 1.6 | 6 | 2.4 | — | — |
| 6 | 1.6 | 5 | 2.4 | 1 | — |
| 7 | 1.6 | 4 | 4.4 | — | — |
| 8 | 1.6 | 4 | 3.4 | 1 | — |
| 9 | 1.6 | — | 5 | — | 3.4 |

All ingredients in each sample were mixed and placed in glass vials. The glass vials were sealed and mixed continuously at room temperature for observation. The vials were visually observed at various times as shown in Table 2 below. The samples were observed for clarity. Visual observation of a cloudy solution or the formation of crystals in the solution indicates that the stevia component had come out of solution. An “X” in the table below indicates that the sample was observed to be not clear (indicating that the stevia component had come out of solution).

TABLE 2

| | Day | | | | | | | | | | |
|---|---|---|---|---|---|---|---|---|---|---|---|
| Sample | 0 | 1 | 2 | 6 | 9 | 13 | 17 | 20 | 30 | 38 | 98 |
| 1 | clear | X | | | | | | | | | |
| 2 | clear | clear | clear | clear | clear | clear | clear | clear | clear | clear | clear |
| 3 | clear | clear | clear | clear | clear | X | | | | | |
| 4 | clear | clear | clear | clear | clear | clear | clear | clear | clear | clear | clear |
| 5 | clear | clear | X | | | | | | | | |
| 6 | clear | clear | clear | clear | clear | clear | clear | clear | clear | clear | clear |
| 7 | clear | clear | X | | | | | | | | |
| 8 | clear | clear | clear | clear | clear | clear | clear | clear | clear | clear | clear |
| 9 | clear | X | | | | | | | | | |

As seen in Table 2, only samples 2, 4, 6, and 8 remained clear at day 98. Sample 4 contains a relatively large amount of ethanol, while samples 2, 6, and 8 contain a lower amount of ethanol.

### Example 2

The 12 samples produced in this example were produced as in example 1, except that ethanol was added in a volume basis. The 12 samples are described in Table 3 below.

TABLE 3

| | | 70% Invert | | | |
|---|---|---|---|---|---|
| | 30% RA95 | sugar syrup | Glycerol | Ethanol | Water |
| Sample | (g) | (g) | (g) | (mL) | (g) |
| 1 | 1.6 | 7.4 | — | 1 | — |
| 2 | 1.6 | — | 8.4 | — | — |
| 3 | 1.6 | — | 7.4 | — | 1 |
| 4 | 1.6 | — | 7.4 | 1 | — |
| 5 | 1.6 | — | 6.4 | — | 2 |
| 6 | 1.6 | — | 5.4 | — | 3 |
| 7 | 1.6 | 5 | 3.4 | — | — |
| 8 | 1.6 | 3 | 5.4 | — | — |
| 9 | 1.6 | 3 | 4.4 | 1 | — |
| 10 | 1.6 | 2.4 | 5 | — | 1 |
| 11 | 1.6 | 1.4 | 6 | 1 | — |
| 12 | 1.6 | 1.4 | 6 | — | 1 |

Samples were observed as in example 1. Results are shown in Table 4 below.

TABLE 4

| | Day | | | | | | | | | | |
|---|---|---|---|---|---|---|---|---|---|---|---|
| Sample | 0 | 3 | 4 | 5 | 6 | 10 | 14 | 17 | 27 | 35 | 98 |
| 1 | clear | clear | clear | clear | clear | X | | | | | |
| 2 | clear | clear | clear | X | | | | | | | |
| 3 | clear | clear | X | | | | | | | | |
| 4 | clear | clear | clear | clear | clear | X | | | | | |
| 5 | clear | clear | clear | clear | clear | clear | clear | clear | clear | clear | X |
| 6 | clear | clear | clear | clear | clear | clear | clear | clear | clear | clear | X |
| 7 | clear | X | | | | | | | | | |
| 8 | clear | X | | | | | | | | | |
| 9 | clear | clear | clear | clear | clear | clear | clear | clear | clear | X | |
| 10 | clear | X | | | | | | | | | |
| 11 | clear | clear | clear | clear | clear | clear | clear | clear | X | | |
| 12 | clear | X | | | | | | | | | |

As seen in Table 4, none of the samples in from example 2 remained clear at 98 days.

### Example 3

Samples used in this example were produced in the same manner as in example 1. Erythritol was utilized in this example in addition to the other ingredients. The invert sugar syrup was adjusted back to pH 4.5 prior to use. Table 5 below describes the samples used in this example.

TABLE 5

| | | 70% Invert | | | |
|---|---|---|---|---|---|
| | 30% RA95 | sugar syrup | Glycerol | Ethanol | Erythritol |
| Sample | (g) | (g) | (g) | (g) | (g) |
| 1 | 1.66 | 2.4 | 4 | 1 | 1 |
| 2 | 1.66 | 2.4 | 3 | 1 | 2 |
| 3 | 1.66 | 2.4 | 2 | 1 | 3 |
| 4 | 1.66 | 7.4 | — | — | 1 |
| 5 | 1.66 | 6.4 | — | — | 2 |
| 6 | 1.66 | 5.4 | — | — | 3 |
| 7 | 1.66 | 4.4 | — | — | 4 |
| 8 | 0.05 | 6.95 | — | — | 3 |
| 9 | 0.066 | 5.934 | — | — | 4 |
| 10 | 0.083 | 4.917 | — | — | 5 |
| 11 | 1.66 | 5 | — | 1 | 3 |
| 12 | 1.66 | 4 | — | 1 | 4 |
| 13 | 1.66 | 3 | — | 1 | 5 |

Samples were observed as in examples 1 and 2. Results are shown in table 6 below.

TABLE 6

Day

| Sample | 0 | 1 | 10 | 17 | 36 | 182 |
|---|---|---|---|---|---|---|
| 1 | Clear | Clear | clear | clear | clear | clear |
| 2 | Clear | Clear | clear | clear | clear | clear |
| 3 | Clear | Clear | clear | clear | clear | X |
| 4 | X | | | | | |
| 5 | X | | | | | |
| 6 | X | | | | | |
| 7 | X | | | | | |
| 8 | Clear | X | | | | |
| 9 | Clear | X | | | | |
| 10 | Clear | X | | | | |
| 11 | Clear | Clear | clear | clear | clear | clear |
| 12 | Clear | Clear | clear | clear | clear | X |
| 13 | Clear | X | | | | |

### Example 4

Samples were produced in similar manner as examples 1-3. Instead of rebaudioside A, the stevia component utilized in this example was either rebaudioside D or rebaudioside D along with a blend of rebaudioside A and rebaudioside B. The rebaudioside D used was a highly pure rebaudioside D (greater than 95% pure). The blend of rebaudioside A and rebaudioside B was also a highly pure blend (greater than 95% pure).

Table 7 describes the samples used in this example on a w/w basis. Total stevia component refers to the total rebaudioside D and the blend of rebaudioside A and rebaudioside B.

For example, in samples A1 and B1 the entire stevia component is made up of rebaudioside D, whereas in samples A2 and B2, rebaudioside D makes up 0.5 of the stevia component while the blend of rebaudioside A and rebaudioside B makes up the remaining amount of the total stevia component.

TABLE 7

| | Total | | 70% | | | | |
|---|---|---|---|---|---|---|---|
| | stevia | Rebaudio- | Invert | | | | |
| Sam- | compo- | side | sugar | | | | |
| ple | nent | D | syrup | Glycerol | Ethanol | Water | Total |
| A1 | 1.3 | 1.3 | 25 | 50 | 10 | 14 | 100.3 |
| A2 | 1.3 | 0.5 | 25 | 50 | 10 | 14 | 100.3 |
| B1 | 1.3 | 1.3 | 38 | 36 | 10 | 14 | 99.3 |
| B2 | 1.3 | 0.5 | 38 | 36 | 10 | 14 | 99.3 |

Samples were observed as in the other examples. Results are shown in table 8.

TABLE 8

| | Day | | | | | | |
|---|---|---|---|---|---|---|---|
| Sample | 0 | 1 | 2 | 3 | 6 | 10 | 13 |
| A1 | clear | X | | | | | |
| A2 | clear | Clear | clear | clear | clear | clear | clear |
| B1 | clear | X | | | | | |
| B2 | clear | Clear | clear | clear | clear | clear | clear |

As seen in this example, a system comprising invert sugar syrup, glycerol, ethanol, and water maintained at least 0.5% rebaudioside D in solution for an extended period of time.

1. A liquid stevia composition comprising:
a stevia component, a syrup component, ethanol, water, and glycerol.

2. The liquid stevia composition of claim 1, wherein the stevia component comprises at least 2% of the composition.

3. The liquid stevia composition of claim 1, wherein the stevia component comprises at least 4% of the composition.

4. The liquid stevia composition of claim 1, wherein the syrup component is an invert sugar syrup.

5. The liquid stevia composition of claim 1, wherein the syrup component is a high invert sugar syrup.

6. The liquid stevia composition of claim 1, wherein the syrup component is a full invert sugar syrup.

7. The liquid stevia composition of claim 1, wherein the ethanol comprises less than 20% of the composition.

8. The liquid stevia composition of claim 1, wherein the ethanol comprises less than 15% of the composition.

9. The liquid stevia composition of claim 1, further comprising erythritol.

10. The liquid stevia composition of claim 1, wherein the water comprises less than 30% of the composition.

11. A liquid stevia composition comprising:
a stevia component, a syrup component, ethanol, water, and erythritol.

12. The liquid stevia composition of claim 11, wherein the stevia component comprises at least 2% of the composition.

13. The liquid stevia composition of claim 11, wherein the stevia component comprises at least 4% of the composition.

14. The liquid stevia composition of claim 11, wherein the syrup component is an invert sugar syrup.

15. The liquid stevia composition of claim 11, wherein the syrup component is a high invert sugar syrup.

16. The liquid stevia composition of claim 11, wherein the syrup component is a full invert sugar syrup.

17. The liquid stevia composition of claim 11, wherein the ethanol comprises less than 20% of the composition.

18. The liquid stevia composition of claim 11, wherein the ethanol comprises less than 15% of the composition.

19. The liquid stevia composition of claim 11, wherein the water comprises less than 30% of the composition.

20. A beverage composition comprising the liquid stevia composition of claim 1.

21. A method of producing a liquid stevia composition comprising:
(a) heating a stevia component in water at a sufficiently high temperature and for a sufficient period of time to dissolve the stevia component in water to yield a heated stevia water solution, and
(b) blending the heated stevia water solution with a syrup component, ethanol, and glycerol.
